(19) United States
(12) Patent Application Publication
(10) Pub. No.: US 2006/0168231 A1
(43) Pub. Date: Jul. 27, 2006

(54) System, apparatus, method, and program for providing virtual books to a data capable mobile phone/device

(76) Inventor: Antoinette Rose DiPerna, Tucson, AZ (US)

Correspondence Address: Antoinette R. DiPerna, 6522 North Pla. Alta Reposa, Tucson, AZ, 85750, US

(21) Appl. No.: 11/111,678

(22) Filed: Apr. 21, 2005

Related U.S. Application Data
(60) Provisional application No. 60/564,168, filed on Apr. 21, 2004.

(51) Int. Cl. G06F 15/173; G06F 15/16

(52) U.S. Cl. 709/226; 709/229

(57) ABSTRACT

A system for delivering data from a host site to a mobile device. The host site comprises a storing unit adapted to store the data. The mobile device comprises a requesting unit adapted to request the data from the host site, and a downloading unit adapted to download the data from the host site to the mobile device when a request from the requesting unit is approved by the storing unit. The data comprises content which is displayed on the mobile device as a virtual book.

### BACKGROUND OF THE INVENTION

1. Field of the Invention

This invention relates generally to the field of data transfer to mobile phones/devices, and more particularly to delivering virtual books including content such as recreational, instructional, and informational content to data capable mobile phones/devices.

2. Related Art

Stories, whether delivered by a tribal raconteur or a working mom, have been handed down from generation to generation. Consider that one of the early forms of communications existed as petroglyphs on rocks or cave paintings on the walls of caves. Modem day storytelling can, of course, still be delivered by a human storyteller from memory or by reading a physical book. However, there are far more sophisticated and desirable options available today. Advanced communications in the form of radio and television broadcasts, videos (e.g., VHS and DVD), desktop/laptop computers, and intelligent purpose-built toys include those utilized on a daily basis.

Stories can be for enjoyment, education, or both. Today's devices can stimulate the brain by presenting material which requires understanding of content, new forms of speech, and problem solving. Use of these devices may also increase motor coordination, particularly in children. The devices that deliver this content are typically both everyday devices such as televisions, VCRs, and, computers, as well as purpose-built devices (e.g., small computers embedded in toys).

One device that has not been utilized for this type of content is a mobile phone/device. Mobile phones/devices are quickly becoming intelligent, robust devices. In the past few years, the world has seen the mobile phone advance from 13-button, no-display, bulky radio units to brilliant, color display, sleek, versatile computing devices. Some of these devices are starting to appear with standardized programmable operating systems (such as the Windows Operating System for desktop computers, for example). Such operating systems, when combined with robust hardware designs, now deliver applications capable of audio, video, robust user interaction, and robust internet web browsing. This platform when enabled with wireless data can become a powerful and capable delivery device.

In most civilized countries, the End Users of mobile phones/devices range from professionals to everyday consumers. Part of this demographic includes, for example, the parents of young children. Parents commonly carry these mobile phones/devices throughout the day to keep in touch with their family, friends, and work. These devices are often carried by the person when he or she leaves the home and are even close by when he or she is in the home.

There is a great need for providing content such as recreational, instructional, and informational content to devices such as mobile phones and their equivalents.

### SUMMARY OF THE INVENTION

The present invention in one embodiment provides a system for delivering data from a host site to a mobile device, wherein the host site comprises a storing unit, adapted to store the data, and the mobile device comprises a requesting unit, adapted to request the data from the host site, and a downloading unit, adapted to download the data from the host site to the mobile device when a request from the requesting unit is approved by the storing unit. The data comprises content which is displayed on said mobile device as a virtual book.

The requesting unit may be adapted to automatically request the data from the host site according to a predetermined schedule. The predetermined schedule may be set by a user. The requesting unit may be adapted to automatically prepare the predetermined schedule based on user preferences.

The requesting unit may be adapted to request the data in response to a manual request. The requesting unit may be adapted to request most recently available data from the host site. The requesting unit may be adapted to request the type of data based on a profile of the user. The data may include at least one of video data, audio data, text data, and still image data.

The requesting unit may request the data in response to a scheduled request. The scheduled request may be prepared based on user preferences. The requesting unit may send the scheduled request based on a signal received from a timer.

The storing unit may be adapted to classify and store the data on the host site according to a type of the data. The storing unit may be adapted to store a list of the data available for download, and the requesting unit may be adapted to request the list for download by the downloading unit and for display.

The host site may be at least one website and/or websites on the Internet. The mobile device may access the host site through a wireless network. The downloading unit may download requested data by streaming the data in real time while displaying the requested data. The downloading unit may be adapted to completely download requested data before displaying the requested data.

The downloading unit may transmit acknowledgment information to the host site upon completion of the download. The downloading unit may create a log including information relating to the download, the information including at least one of an error message and a confirmation message. If the log includes the error message, the requesting unit transmits the error message to the host site and again requests the data from the host site. The error message may indicate an incomplete download or that incorrect data was received.

When the error message is created, the user may be provided with the option of requesting other data or terminating delivery. When the error message is created, the requesting unit may request a list of data from the host site which is similar to the originally requested data.

A displaying unit may display a list of the downloaded data, a list of the data available for download, and/or the downloaded data.

The requesting unit may request the data based on the type of the data manually selected by a user. The requesting unit may create a list of desired data according to a user profile. The requesting unit may create a list of desired data according to a wishlist created by a user. The requesting unit may request the desired data from the host site, and if the desired data is available for download, the downloading unit may download the desired data from the host site. If the desired data is not available for download, the host site may notify the downloading unit upon the desired data becoming available for download. The requesting unit may search the list for a type of the data.

The host site may send a notification to the downloading unit when new data is available for download. The user may be notified when the desired data becomes available for download. The host site may send a notification to the downloading unit notifying of new data soon to be available for download. The requesting unit may request the new data from the host unit in accordance with one of a user profile and a user request. The requesting unit may transmit a message to the host site acknowledging the notification of new data, and declining download of the new data. If no response to the notification is received by the host site after a predetermined time period, the host site may queue the new data for later download and archive the new data. If no response to the notification is received by the host site after a predetermined time period, the host site may re-send the notification.

The virtual book may be displayed on the mobile device page by page. Virtual pages of the virtual book may be turned automatically. Virtual pages of the virtual book may be turned as commanded by a user. Audio data may be sounded along with the display of the virtual book. The audio data may include at least one of speech and music.

The mobile device may be a cell phone, a beeper, a pager, a PDA, or others.

The downloading unit may be notified of a fee associated with the download.

The data may comprises advertising information.

The present invention in another embodiment provides a mobile device for displaying data downloaded from a host site on a mobile device, comprising a requesting unit, adapted to request the data from the host site, and a downloading unit, adapted to download the data from the host site to the mobile device when a request from the requesting unit is approved, wherein the data comprises content which is displayed on the mobile device as a virtual book.

The present invention in another embodiment provides a method of delivering data from a host site to a mobile device, comprising a storing step of storing the data on the host site, a requesting step of requesting the data from the host site, and a downloading step of downloading the data from the host site to the mobile device when a request of the requesting step is approved, wherein the data comprises content which is displayed on the mobile device as a virtual book.

The present invention in another embodiment provides a storage medium storing a program for executing a method of displaying data downloaded from a host site on a mobile device, the program comprising program code of a requesting step of requesting the data from the host site, and program code of a downloading step of downloading the data from the host site to the mobile device when a request of the requesting step is approved, wherein the data comprises content which is displayed on the mobile device as a virtual book.

The present invention in another embodiment provides a system for delivering data from a host site to a mobile device. The host site comprises a storing unit adapted to buffer and store the data, and a notifying unit adapted to transmit a notification of the stored data and to approve requests for the stored data. The mobile device comprises a scheduling and requesting unit adapted to request the data from the host site according to the notification and according to at least one of a scheduled request and a manual request, and a downloading unit adapted to download the data from the host site to the mobile device when a request from the requesting unit is approved by the notifying unit. The data comprises content which is displayed on the mobile device as a virtual book.

The present invention in another embodiment provides a system for delivering data from a host site to a mobile device through a data processing device, comprising a storing unit adapted to store the data on the host site, a requesting unit adapted to request the data from the host site, a downloading unit adapted to download the data from the host site to the data processing device when a request from the requesting unit is approved, and a transmitting unit adapted to transmit the downloaded data to the mobile device. The data comprises content which is displayed on the mobile device as a virtual book. A user may access the host site from the data processing device to request data for delivery to the mobile device.

The present invention in another embodiment comprises a storage medium storing data read by a data processing device for display on a mobile device communicating with the data processing device and requesting the data, wherein the data comprises content which is displayed on the mobile device as a virtual book.

The present invention in another embodiment comprises a storage medium storing data downloaded by a mobile device requesting the data, wherein the data comprises content which is displayed on the mobile device as a virtual book.

### BRIEF DESCRIPTION OF THE DRAWINGS

The invention will be more clearly understood by referencing it to the following detailed description of exemplary embodiments in conjunction with the accompanying drawings, in which:

FIG. 1 illustrates a system for delivering content to a mobile phone/device in accordance with one embodiment of the present invention;

FIG. 2 illustrates a system for delivering content to a mobile phone/device in accordance with another embodiment of the present invention;

FIG. 3 illustrates a process of requesting and delivering content, in accordance with an embodiment of the present invention;

FIGS. 4 and 5 illustrate scenarios in which new content is available for download, in accordance with the present invention; and

FIG. 6 illustrates a scenario in which the mobile is in an unreachable state, in accordance with the present invention.

The present invention will next be described in connection with certain exemplary embodiments. However, it should be clear to those skilled in the art that various modifications, additions, and subtractions can be made without departing from the spirit or scope of the claims.

### DETAILED DESCRIPTION OF THE INVENTION

The present invention in one embodiment provides a data capable mobile device, capable of receiving content and delivering it to a user. The present invention can take advantage of one or more of the device hardware, operating system, software, wireless data network, and the Internet in order to deliver specifically focused rich content to the device and End User(s). The content can include recreational, instructional, and informational content, and can include literature and games. The content can be aimed at children, parents, teachers, or all persons, of any age, interested in receiving entertainment or informational content, for example. This information can be retrieved in forms which include video data, audio data, text data, music, games, applications, and other types of software. The content itself can include, but is not in any way limited to, childrens' videos, childrens' music, childrens' learning applications/games, childrens' storybooks, childrens' cartoons, and other informational or educational content that uses a combination of video/audio and applications. The content can be tailored to others as well, for example by providing virtual novels for reading by the user. The phone/device can be combined with the content above and related ‘themes’ to ultimately form a device for parents, children, or people of all ages.

It is to be understood that the term “virtual book” as used herein includes content such as, for example, a novel, a book, a newspaper, a magazine, a pamphlet, a story, a training manual, a training guide, and others, which can be displayed page by page (if there is more than one page) on the mobile device, as if the user of the mobile device is reading a book. The virtual book can be displayed and accompanied by text, pictures, still video, moving video, animated pictures, and audio such as music, speech, etc.

In one embodiment of the invention the ‘home screen’ or display of the device has images related to the latest available content and links to both previously available and newly available content. This information can be automatically updated to the phone/device by a scheduled process on the device, or a ‘pushed’ message to the device. The choice can be left to the user. The phone/device can be configured to download the latest content, or wait for the user to request the content. The user can also receive ‘coming attractions’ displaying content which will be available in the future. The present invention can also deliver specifically tailored advertisements according to the user in response to the user's profile, or the user's selection of content. Such advertisements could include product advertisements, advertisements representing new content available for download, or others.

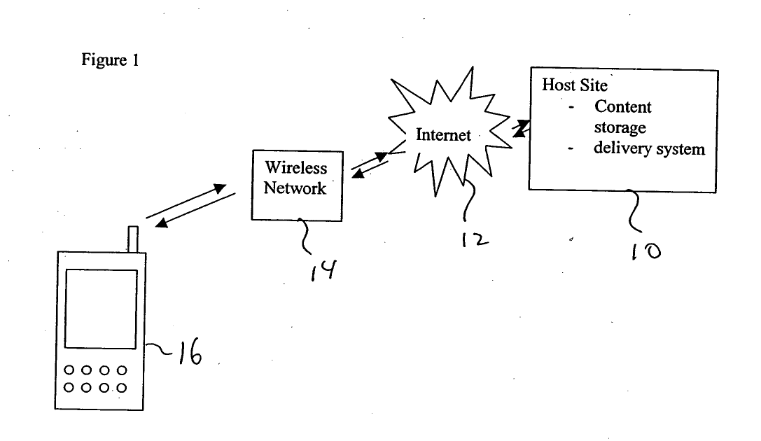

FIG. 1 illustrates a system for delivering content to a mobile phone/device in accordance with one embodiment of the present invention. Delivery of content is achieved via a wireless data connection that passes through a wireless data service provider. A host site 10 stores content which can be delivered to a mobile phone/device 16. The mobile phone/device 16 accesses the Internet 12 by way of a wireless network 14, and downloads content or a list of the content which is available for download. The host site 10 can be a website or websites, and can categorize the content according to type. Different types of content can include for example, content for children or teachers or adults; novels or instructional material; literature pertaining to sports or politics; fiction or nonfiction; or others. Content can be provided that is specifically tailored to the user(s). The content can be ‘streamed’ in real-time or completely downloaded to the device, for example. Once the content reaches the device, it can be displayed in various forms, thereby taking advantage of the robust features of the mobile device. Such forms include text, video, audio, photographs, etc., or some combination of these.

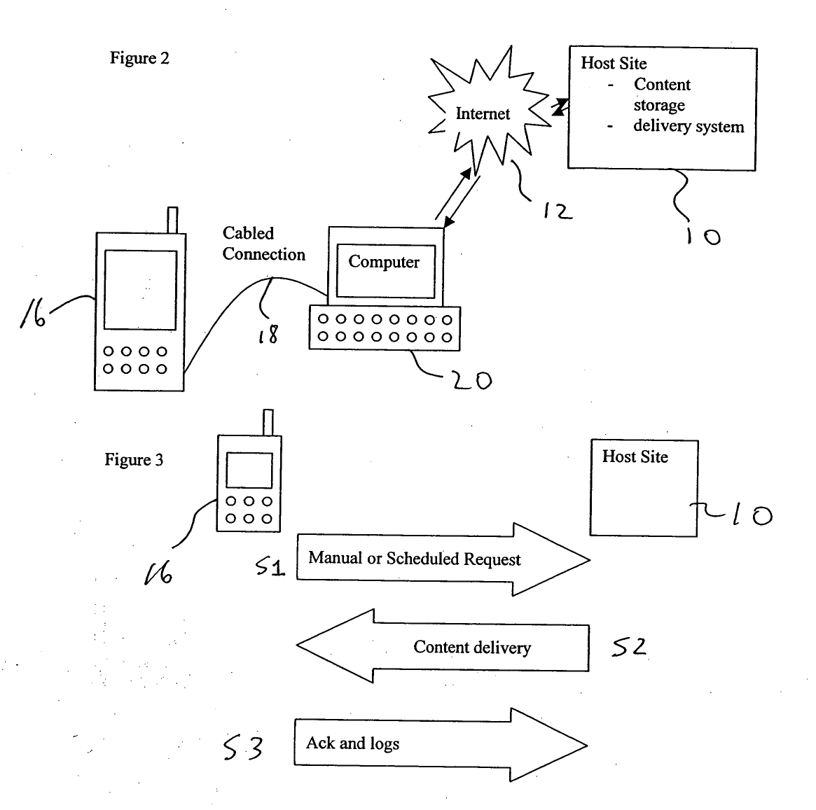

FIG. 2 illustrates a system for delivering content to a mobile phone/device in accordance with another embodiment of the present invention. In the embodiment shown in FIG. 2, delivery is achieved via a local pass-through connection to the user's computer which is connected to the public Internet. A host site 10 stores content to be delivered to a mobile phone/device 16. The mobile phone/device 16 accesses the Internet 12 by way of a cabled connection 18 to a computer 20 such as a desktop or laptop. In this setup, the computer 20 downloads the content or a list of the content which is available for download from the host site 10, and then delivers the content to the mobile device 16.

As in the embodiment shown in FIG. 1, the host site 10 can be a website or websites, and can categorize the content according to type, thereby providing content that can be specifically tailored to the user. The content can be ‘streamed’ in real-time or completely downloaded to the device for example. Once the content reaches the device, it can be displayed in various forms, thereby taking advantage of the robust features of the mobile device 16.

It is of course to be understood by those of skill in the art that various modifications of the embodiments described herein can be made without departing from the scope and spirit of the invention. For example, although a cabled connection is shown in FIG. 2, the connection could be wireless, such as a wireless data connection through a mobile operator. The mobile device 16 could be communicatively coupled to the computer 20 through any suitable type of communication link, using, for example, cable, telephone, or other wireless technologies.

In addition, instead of a host site 10 storing the content, content could be stored on a computer-readable medium such as a compact disc, and the compact disc could be read by the computer 20 for accessing the content. Media storing the content could be delivered to the user periodically. Alternatively, the mobile device 16 could sync up to a medium such as a removable memory to access the content.

FIG. 3 illustrates a process of requesting and delivering content from the host site 10 according to an embodiment of the present invention. Requests include manual requests and scheduled requests. Manual requests enable the user to choose data/content for delivery and then start the download of such content manually. Scheduled requests enable data/content to be automatically downloaded, for example via a predetermined schedule. The schedule can be programmed in advance by the user, or can be programmed by the mobile device 16 automatically based on user-implemented preferences or based on the user's profile.

In Step S1 of FIG. 3, a scheduled or manual request to download content is sent from the mobile device 16 to the host site 10. The process for sending a scheduled request can be achieved, for example, with a timer. For manual requests, the user can submit such requests through an exposed user interface. In Step S2 the host site 10 delivers the requested content, if it is available, to the mobile device 16 or to a computer 20 connected to the mobile device 16. In Step S3, the mobile device 16 transmits acknowledgments back to the host site 10 to confirm that delivery was completed and that the requested content was received. A log of this information is created as well. If an error occurred somewhere in the process, for example the delivery was incomplete, or the transmission was prematurely terminated, or the wrong content was received, etc., an error message is created and stored in the log, and this information is transmitted back to the host site. At this point the data can be re-transmitted in whole or part, or can be otherwise corrected.

If, for example, the requested content is not available, the host site 10 will update the error log and send a notification to the mobile device 16 or the computer 20. The user then has the option of requesting other content or terminating the process. The host site can also suggest content as a replacement, for example content that may be similar to the originally requested content.

The interface of the mobile device 16 is set up to allow the user to easily navigate through the available options. In one embodiment, the user uses the keys on the device 16 to select from a menu the options relating to the provision of content. The user is provided with options such as viewing a list of the content available for download, viewing the downloaded content, creating a schedule for requesting content, creating a content request, creating a user profile, choosing the type(s) of content the user wishes to download, creating a so-called wish list of desirable content, etc. The user profile may also be created automatically by the device based on the user's selections. The device can also be set up to automatically downloaded specific items on the wishlist (e.g. content of a particular type, or specific content by a particular author), or to notify the user when items on the wishlist are available for download. The user is also provided with the option of accessing the host site from the device or computer and using an interface on the host site to review and/or request content.

The user may interact with the mobile device 16 using the architecture of the mobile device 16 which may include, for example, a keyboard, a mouse, a touch screen, a trackball, and/or any other suitable type of user-operable input device(s). The output user interface may include, for example, a video display, a liquid crystal or other flat panel display, a speaker, and/or any other suitable type of output device for enabling a user to perceive outputted information.

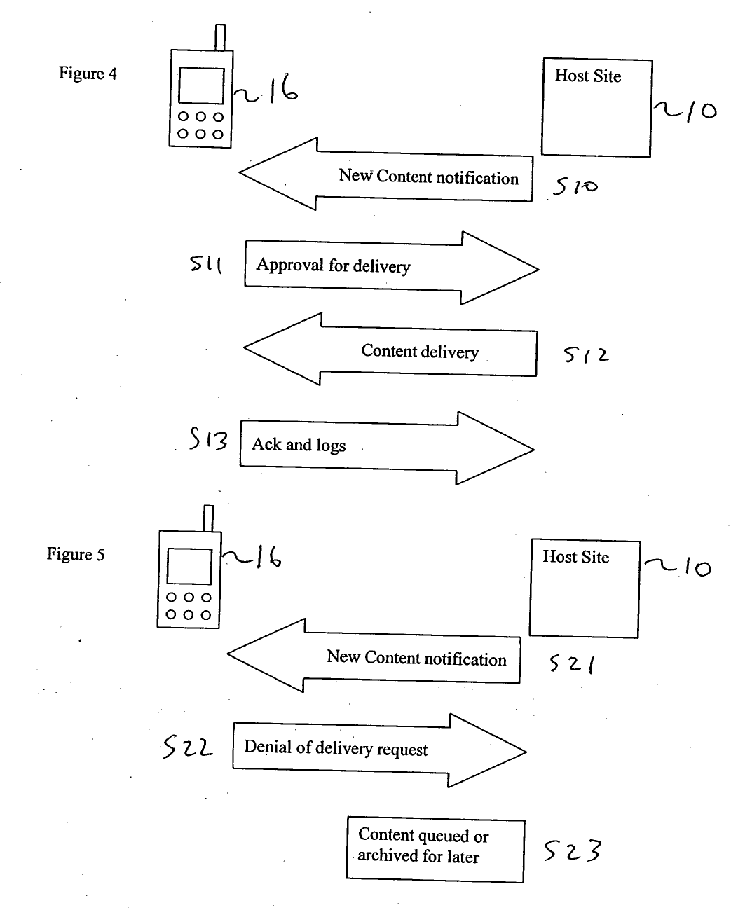

FIGS. 4 and 5 each illustrate scenarios in which new content is available for download, according to embodiments of the present invention. The mobile device 16 can be configured such that a host-initiated notification informs the mobile device 16 that there is content available for download which may be desired by the user. The mobile unit 16 can then acknowledge to either start or postpone download. The mobile unit 16 can also inform the user that new content is available for download; or, in accordance with automatic operation based on for example the user's profile or the user's instructions, the mobile unit 16 can decide automatically to approve the content for delivery or deny the delivery request.

In Step S10 of FIG. 4, the host site 10 transmits a message to the mobile device 16 informing the device 16 that new content is available for download. In the scenario illustrated in FIG. 4, the device 16 approves the content for delivery in Step S11. The host site 10 then sends the content to the mobile device 16 in Step S12. In Step S13, acknowledgments are sent and logs are created in accordance with the present invention as explained herein.

In Step S20 of FIG. 5, the host site 10 transmits a message to the mobile device 16 informing the device 16 that new content is available for download. In the scenario illustrated in FIG. 5, the device 16 denies the delivery request in Step S21. The host site 10 then archives the content and/or queues the content for later delivery in Step S22.

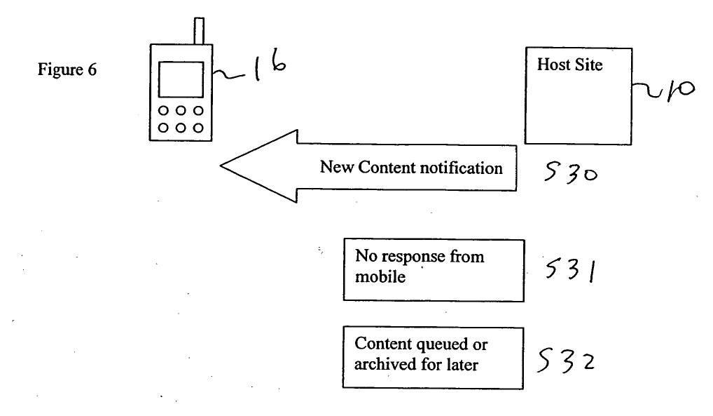

FIG. 6 illustrates an embodiment of the present invention in which, in the event that the mobile device 16 is in an unreachable state (for example it is powered off or out of battery power), the Host notification will be timed out. In Step S30 the host site 10 transmits a notification to the mobile device 16 informing the device 16 that new content is available for download. If there is no response from the mobile device 16 after a predetermined period of time, the Host notification is timed out. Following the timeout, the host can decide to archive or queue the content for later delivery for when the designated mobile device resumes operation. The content can also be deleted. The host site can repeat Step S30 by re-transmitting the notification to the mobile device 16 in predetermined time intervals, in order to check whether the device 16 has resumed operation.

The possibility for utilizing a device for enriching a child's or other person's experience is great. In the case of children, it can be easy to foresee the use and application of such a device in a number of various settings. For example, in one example, the device can be used in the child's home play space, in his day care play space, or at the local supermarket cart where a parent could prop the phone/device into the cart or allow the child to hold it. The parent can then push ‘play’ and the phone/device pops open the latest childrens' book which had been automatically downloaded overnight. The childrens' book, adapted or created to fit in and be properly displayed on the data capable mobile device, can be delivered visually by way of a vivid screen display and audio via the speaker on the device. The virtual book can flip through page by page (with enhanced visual animation) automatically or manually, and can be narrated by a story-teller. As such, the child can watch, listen and learn the story while the parent is shopping. Effectively, the parent in this example can get on-demand children's content via a mobile phone/device. Other options are available for users of any age. It is of course to be understood that the examples described herein are illustrative only and in no way limit the present invention to the details described.

It should be noted that while the invention has been described above in the context of mobile phones/devices, the invention is not limited to such. For example, beepers/pagers, such as Blackberry pagers, that have visual and interactive capabilities along with a means of downloading the content (for example, over the air or attached to a computer) could be used as well; another example is a PDA (Personal Digital Assistant) such as a PalmPilot, SmartPHone, or PocketPC. Furthermore, this content can be used not only for recreational use, but can be used to provide instructional video/audio to an employee, such as, for example, an Airport Security Guard who can instantly learn what the latest suspicious shoes may look like by watching a downloaded training video.

As explained above, data is not limited to content specifically designed for children. Data/content can also be geared to parents for instructional purposes to suit the needs of the parents/teachers with regard to child rearing or health and safety issues. Additional, unrelated material suitable for the instruction or entertainment of the general public could also be delivered via the data capable mobile device of according to the present invention.

Additionally, there are numerous options available for charging users fees for use. The method of payment for the downloaded content can be by license agreement or subscription. Users can pay per item of content downloaded or per block of items of content downloaded, for example. Users can also be charged a daily, montly, or yearly fee, for example, thus giving that user unlimited access to downloads of content, or access limited by certain restrictions depending on the plan the user selects.

Furthermore, the user can determine which type or genre of content he or she wishes to download, or which type or genre he or she wishes to receive notifications of. The user can choose to automatically download the latest content periodically (e.g. hourly, daily, weekly, monthly, etc.), or automatically as new content in a particular genre is available, for example. The user can choose to automatically download and/or display content at a certain time of day.

The user can program a schedule as well, and program how often content is to be delivered, as well as a requested type or genre. The mobile device can be programmed such that it searches the list of available content for specific criteria, such as a specific topic or author. The mobile device can be programmed such that it specifically notifies the host of desirable content, which information the host can use to notify the host administrator that such content is desired, or search for such content itself.

Data can be uploaded to the host site by a site administrator or by authorized content providers. Various data compression/encoding, decompression/decoding, and storage techniques are well known in the art and can be used to implement this invention.

In one example a controller controls the operations of the host site, including storage of the content on the host site, cataloging the content, and delivering the content to the mobile device. A controller in the mobile device controls the scheduling, media processing/playback, requesting of content, and user interaction.

Low power techniques are also used to prolong the on-time of the device. For example, audio options can be turned off or the volume lowered. As an example, if content is being read by a virtual narrator according to the features of the present invention, that audio can be turned off or down.

A storage medium for storing program code of software for executing the functions of the present invention can be provided in a system or apparatus. A computer, such as a CPU or MPU, in the system or apparatus can read and execute the program code stored in the storage medium. In this way, the functions of the present invention can be implemented. The storage medium for supplying the program code can be a hard disk, a floppy disk, an optical disk, a magneto-optical disk, a CD-ROM, a CD-R, a magnetic tape, a nonvolatile memory card, a ROM, and others. The functions of the present invention can also be realized by executing some or all of the processing by an operating system which operates on a computer on the basis of the instructions of the program code.

While the invention has been particularly shown and described with respect to preferred embodiments thereof, it will be understood by those skilled in the art that changes in form and details may be made therein without departing from the scope and spirit of the invention.

Having described the invention, what is claimed as new and secured by Letters Patent is:

1. A system for delivering data from a host site to a mobile device, wherein
said host site comprises:
a storing unit, adapted to store the data; and
said mobile device comprises:
a requesting unit, adapted to request the data from said host site, and
a downloading unit, adapted to download the data from said host site to said mobile device when a request from said requesting unit is approved by said storing unit,
wherein the data comprises content which is displayed on said mobile device as a virtual book.

2. The system as set forth in claim 1, wherein said requesting unit is adapted to automatically request the data from said host site according to a predetermined schedule.

3. The system as set forth in claim 2, wherein the predetermined schedule is set by a user.

4. The system as set forth in claim 2, wherein said requesting unit is adapted to automatically prepare the predetermined schedule based on user preferences.

5. The system as set forth in claim 1, wherein said requesting unit is adapted to request the data in response to a manual request.

6. (canceled)

7. (canceled)

8. The system as set forth in claim 1, wherein said storing unit is adapted to classify and store the data on said host site according to a type of the data.

9. The system as set forth in claim 1, wherein said storing unit is adapted to store a list of the data available for download, and said requesting unit is adapted to request the list for download by said downloading unit and for display.

10. The system as set forth in claim 1, wherein said host site is at least one website on the Internet.

11. (canceled)

12. The system as set forth in claim 8, wherein said requesting unit is adapted to request the type of data based on a profile of the user.

13. The system as set forth in claim 1, wherein said downloading unit is adapted to download requested data by streaming the data in real time while displaying the requested data.

14. The system as set forth in claim 1, wherein said downloading unit is adapted to completely download requested data before displaying the requested data.

15. A system for delivering data from a host site to a mobile device through a data processing device, comprising:
a storing unit, adapted to store the data on said host site;
a requesting unit, adapted to request the data from said host site;
1a downloading unit, adapted to download the data from said host site to said data processing device when a request from said requesting unit is approved; and
a transmitting unit, adapted to transmit the downloaded data to said mobile device,
wherein the data comprises content which is displayed on said mobile device as a virtual book.

16. The system as set forth in claim 1, wherein said requesting unit is adapted to request the data in response to a scheduled request.

17. The system as set forth in claim 16, wherein the scheduled request is
prepared based on user preferences.

18. (canceled)

19. (canceled)

20. (canceled)

21. (canceled)

22. (canceled)

23. (canceled)

24. (canceled)

25. (canceled)

26. (canceled)

27. The system as set forth in claim 1, further comprising a displaying unit, adapted to display a list of the data available for download.

28. The system according to claim 8, wherein said requesting unit is adapted to request the data based on the type of the data manually selected by a user.

29. (canceled)

30. (canceled)

31. (canceled)

32. (canceled)

33. (canceled)

34. (canceled)

35. (canceled)

36. (canceled)

37. (canceled)

38. The system as set forth in claim 1, wherein said host site sends a notification to said downloading unit when new data is available for download.

39. The system as set forth in claim 38, further comprising a notifying unit, adapted to notify a user that the new data is available.

40. The system as set forth in claim 38, wherein said requesting unit is adapted to request the new data from said host unit in accordance with one of a user profile and a user request.

41. The system as set forth in claim 38, wherein said requesting unit is adapted to transmit a message to said host site acknowledging the notification, and declining download of the new data.

42. The system as set forth in claim 38, wherein, if no response to the notification is received by said host site after a predetermined time period, said host site queues the new data for later download and archives the new data.

42. (canceled)

44. The system as set forth in claim 1, wherein the virtual book is displayed on the mobile device page by page.

45. The system as set forth in claim 44, wherein virtual pages of the virtual book are turned automatically.

46. The system as set forth in claim 44, wherein virtual pages of the virtual book are turned as commanded by a user.

47. The system as set forth in claim 44, wherein audio data is sounded along with the display of the virtual book.

48. (canceled)

49. (canceled)

50. (canceled)

51. (canceled)

52. (canceled)

53. (canceled)

54. A mobile device for displaying data downloaded from a host site on a mobile
device, comprising:
a requesting unit, adapted to request the data from said host site; and
a downloading unit, adapted to download the data from said host site to said mobile device when a request from said requesting unit is approved,
wherein the data comprises content which is displayed on said mobile device as a virtual book.

55. (canceled)

56. (canceled)

57. A system for delivering data from a host site to a mobile device, wherein
said host site comprises:
a storing unit, adapted to store the data, and
a notifying unit, adapted to transmit a notification of the stored data and to
approve requests for the stored data; and
said mobile device comprises:
a scheduling and requesting unit, adapted to request the data from said
host site according to the notification and according to at least one of a scheduled
request and a manual request, and
a downloading unit, adapted to download the data from said host site to said mobile device when a request from said requesting unit is approved by said notifying unit,
wherein the data comprises content which is displayed on said mobile device as a virtual book.

58. (canceled)

59. The system as set forth in claim 1, wherein said host site sends a notification to said downloading unit notifying of new data soon to be available for download.

60. A storage medium storing data read by a data processing device for display on a mobile device communicating with said data processing device and requesting the data, wherein the data comprises content which is displayed on said mobile device as a virtual book.

61. (canceled)

62. The system as set forth in claim 15, wherein a user accesses said host site from said data processing device to request data for delivery to said mobile device.

63. (canceled)

64. The system as set forth in claim 38, wherein if no response to the notification is received by the host site after a predetermined time period, the host site re-sends the notification.
